(19) United States
(12) Patent Application Publication
(10) Pub. No.: US 2007/0194773 A1
(43) Pub. Date: Aug. 23, 2007

(54) Method and device for detecting contaminants on turbine components

(76) Inventors: Michael Dankert, Offenbach (DE); Matthias Oechsner, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/591,511

(22) PCT Filed: Mar. 1, 2005
(86) PCT No.: PCT/EP05/50881

§ 371 Date: Sep. 1, 2006

(30) Foreign Application Priority Data
Mar. 3, 2004 (EP) 04004981.9

(51) Int. Cl. G01N 27/00

(52) U.S. Cl. 324/71.2

(57) ABSTRACT

To detect contaminants on turbine components of a turbine, at least one current oscillation characteristic value of at least one turbine component is determined. Said value is preferably compared to an oscillation reference value. This permits contaminants to be detected, as the weight of the latter modifies the oscillation characteristic value of the turbine component.

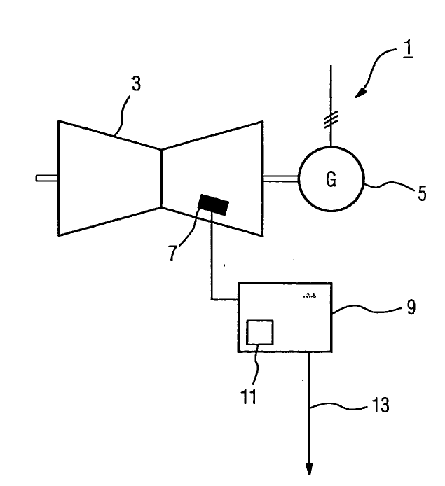

### CROSS REFERENCE TO RELATED APPLICATIONS

This application is the US National Stage of International Application No. PCT/EP2005/050881, filed Mar. 1, 2005 and claims the benefit thereof. The International Application claims the benefits of European Patent application No. 04004981.9 filed Mar. 3, 2004. All of the applications are incorporated by reference herein in their entirety.

### FIELD OF THE INVENTION

The invention relates to a method and a device for detecting contaminants on turbine components, especially components of a gas turbine for generating electrical energy.

### BACKGROUND OF THE INVENTION

With a turbine for generating electrical energy, energy contained in the working medium is converted into rotation energy of the turbine, a generator coupled to the turbine is driven and electrical power provided.

Different turbine types are known, for example gas turbines or steam turbines. With gas turbines the heating gas used to drive the gas turbine is usually created in a combustion chamber, with heavy oil or Naphtha being used as fuel for the burner for example.

Burning these fuels produces heating gas which contains contaminant particles. The heating gas is directed onto the turbine blades of the turbine and in doing so causes the turbine blade rim to rotate. All turbine components which come into contact with the hot gas are in danger of being contaminated, since at least some of the contamination particles are deposited when the contaminated hot gas comes into contact with the turbine components. The turbine blades in particular are affected here.

The contaminants cause the characteristics of the turbine, especially its efficiency, to change. Furthermore these contaminants can also lead to the imposition of a disproportionate load on the turbine. The contaminants generally form unwanted deposits on the turbine components involved, whereby the fuel used, the environmental conditions or the mode of operation influence the level of deposits formed or the speed of formation.

The deposits must be removed by cleaning the turbine components involved. In this context undertaking the cleaning at regular inspection intervals is known. In such cases a visual inspection of the turbine components is usually undertaken beforehand, in which case at least a part of the turbine has to be dismantled to allow the visual inspection to be conducted.

The visual inspection can for example reveal that cleaning is not actually necessary yet or on the other hand it can reveal that damage to turbine components has already occurred. The specification of predetermined cleaning intervals means that detecting the ideal cleaning point is more or less a matter of chance.

### SUMMARY OF THE INVENTION

The underlying object of the invention is thus to specify an improved method and also a device for detecting contaminants on turbine components of a turbine with which in particular there is no need to dismantle the turbine.

Furthermore this method and the device are designed to allow the optimum possible cleaning time to be defined.

As regards the method, the object of the invention is achieved by a method for detecting contaminants on turbine components of a turbine, with a least one current oscillation characteristic value of at least one turbine component being determined.

The invention is based on the idea that the rotating components of a turbine in particular oscillate as a result of the forces acting on them. This oscillation can be more or less sharply defined as regards its amplitude and/or attenuation and can extend from a rapidly decaying impact through to an unattenuated harmonic oscillation.

Furthermore the frequency at which the turbine component involved oscillates can be used as the oscillation characteristic value.

It should be pointed out that these types of oscillations can be detected in any operating situation of the turbine, i.e. in normal operation as well.

Advantageously the oscillation characteristic value is determined during the operation of the turbine.

A few oscillation characteristics of a turbine component to which contaminated hot gas is applied manifest themselves during the operation of the turbine, that is when hot gas is applied to the turbine and the turbine blades are rotating.

As already mentioned, forces act on the components of a turbine while it is operating which cause the components affected to react with a more or less sharply marked oscillation as a reaction. The type of oscillation produced by this depends in this case on the degree of contamination of the component. For example the mass of the component alters as a result of the contamination. This means that the oscillation which sets in during the operation of this component, is more strongly attenuated and/or has another frequency compared to a non-contaminated component. If this type of oscillation characteristic value of the turbine component which is in operation is now determined, contamination of the turbine component can be deduced from this and a cleaning plan defined.

In a further advantageous embodiment of the invention the oscillation characteristic value is determined while the turbine is stationary.

No external forces act on the turbine components when the turbine is stationary. The oscillation characteristics of the component can however have changed in the previous phase of operation. For example the inherent frequency of a contaminated component shifts compared to the frequency of a non-contaminated component.

When the turbine is stationary, this can for example be established by the turbine being excited, directly or indirectly, by an impact for example, and by measuring the component oscillation which then occurs.

Advantageously the oscillation characteristic value is compared with an oscillation reference value which is assigned to an appropriate non-contaminated component. For example the inherent frequency of the contaminated component and of a corresponding similar non-contaminated turbine component are determined and compared to each other. If these two values differ it can be deduced that the turbine component under investigation is contaminated.

In a further advantageous embodiment the turbine component is a turbine blade. The turbine blades are those turbine components which are most intensively in contact with the hot gas during operation. There is thus likely to be a build-up of contaminants especially on the turbine blades and the operation of the turbine is likely to be adversely affected. It is thus especially advantageous to investigate one, a number or all turbine blades of the turbine with respect to their current oscillation characteristic value in order to enable contaminants to be identified at an early stage.

In an especially advantageous embodiment at least one common oscillation characteristic value is determined for a number of turbine components operated in a comparable manner. Usually a number of rows of turbine blades are arranged behind one another and the hot gas flows over each of them in turn. Thus the turbine blades of one of these rows are operated in a comparable manner in that the hot gas is applied in parallel to these turbine blades. As a result of the symmetrical construction of the turbine, especially with regard to the arrangement of the turbine blades, an equal load is thus imposed on the turbine blades of one row of blades.

In a further advantageous embodiment the turbine component directs hot gas. These types of turbine component not only include the turbine blades mentioned but also other components which come into contact with the hot gas such as for example hot gas intake lines or hot gas lines. In this embodiment of invention these types of turbine component can also be investigated for contamination.

Especially preferably the oscillation characteristic value comprises an inherent frequency and/or an oscillation frequency and/or an oscillation amplitude and/or an attenuation characteristic value and/or an oscillation decay behavior of the turbine component.

These oscillation characteristic values can be determined in operation or while the turbine is stationary. During operation, to determine these characteristic values, the turbine components to be investigated do not usually have to be excited separately since they are excited into oscillations in any event during the operation as a result of the forces acting on them (for example centrifugal forces and/or slight unbalances). The corresponding oscillation characteristic value in respect of this oscillation or these oscillations is then determined.

While the turbine is stationary on the other hand the requirement is generally to determine the oscillation characteristic value by exciting the turbine component directly or indirectly by means of an impact and to determine the oscillation characteristic value which occurs.

The invention also leads to a device for detecting contaminants on turbine components of a turbine, whereby at least one sensor unit for determining at least one current oscillation value of at least turbine component is provided.

Further preferred embodiments of the inventive device are to be found in the corresponding dependent patent claims.

### BRIEF DESCRIPTION OF THE DRAWINGS

An exemplary embodiment of the invention is explained in more detail below. The Figures show:

FIG an inventive device for detecting contaminants on turbine components of a turbine.

### DETAILED DESCRIPTION OF THE INVENTION

The figure shows an inventive device 1 for detecting contaminants on turbine components of a turbine 3. The turbine 3 is preferably a gas turbine of which the turbine blades are driven by hot gas. To generate electrical energy the turbine 3 is linked to a generator 5.

A sensor unit 7 is provided to record an oscillation characteristic value of the turbine blades. This sensor unit can be accommodated on the outside of the turbine housing and for example pickup switching frequency of a set of turbine blades moving past the sensor unit 7.

Furthermore the sensor unit 7 can be arranged within the turbine housing and for example pick up on an inductive basis measured values of turbine blades moving past it.

It is also conceivable for the sensor unit 7 to be embodied as a highly integrated device and for example be accommodated in the shape of a foil on at least one turbine blade. The measured values detected in this way can be read out using a non-contact and/or wireless method.

The processing unit 9 comprises a memory 11 in which an oscillation reference value is stored which corresponds to a turbine blade which is not contaminated, i.e. which has no deposits on it.

The oscillation characteristic value or the oscillation reference value can comprise an inherent frequency and/or an oscillation frequency and/or an oscillation amplitude and/or an attenuation characteristic value and/or an oscillation decay behavior of the turbine component. In the present embodiment the turbine component is one or more turbine blades.

The oscillation characteristic value is determined during the operation of the turbine 3 alternately or in combination while the turbine is stationary.

The processing unit 9 can for example be implemented by means of a digital computer in which an evaluation program is used which equalizes the oscillation characteristic value or values determined in relation to the turbine blade in accordance with an evaluation algorithm with the stored oscillation reference value or values. Depending on at the level of match or also deviation of the said values, a maintenance instruction 13 can be generated, for example based on methods of artificial intelligence.

1-18. (canceled)

19. A method for detecting contamination on a turbine component of a turbine, comprising:
pre-determining a reference oscillation characteristic value of the turbine component;
determining a current oscillation characteristic value of the turbine component;
comparing the current oscillation characteristic value with the pre-determined oscillation characteristic value; and
assessing the contamination level of the turbine component based on the comparison.

20. The method as claimed in claim 19, wherein the current oscillation characteristic value is determined when the turbine is operating.

21. The method as claimed in claim 19, wherein the current oscillation characteristic value is determined while the turbine is not operating.

22. The method as claimed in claim 19, wherein the turbine component is a turbine blade.

23. The method as claimed in claim 19, wherein a common current oscillation characteristic value is determined for a plurality of turbine components that operate comparably.

24. The method as claimed in claim 23, wherein the plurality of turbine components operated in a comparable manner is a row of turbine blades.

25. The method as claimed in claim 23, wherein the plurality of turbine components direct a hot gas.

26. The method as claimed in claim 19, wherein the current oscillation characteristic value is a behavior of the turbine component that is selected from the group consisting of: inherent frequency, oscillation frequency, oscillation amplitude, attenuation characteristic value and oscillation decay.

27. A device for determining a degree of contamination on a turbine component of a turbine, comprising:
a sensor unit that determines a current oscillation characteristic value of the turbine component; and
a processor unit that compares the current oscillation characteristic value of a turbine component with a pre-determined reference oscillation characteristic value of a turbine component and determines the degree of contamination of the turbine component based on the comparison.

28. The device as claimed in claim 27, wherein the current oscillation characteristic value is determined while the turbine is operating.

29. The device as claimed in claim 27, wherein the oscillation characteristic value is determined while the turbine is stationary.

30. The device as claimed in claim 27, wherein the turbine component is a turbine blade.

31. The device as claimed in one of the claim 27, wherein a common current oscillation characteristic value is determined by the sensor unit for a plurality of turbine components that operate comparably.

32. The device as claimed in claim 31, wherein the plurality of turbine components that operate comparably is a row of turbine blades.

33. The device as claimed in claim 32, wherein the plurality of turbine components direct a hot gas.

34. The device as claimed in claim 27, wherein the current oscillation characteristic value is a behavior of the turbine component that is selected from the group consisting of: inherent frequency, oscillation frequency, oscillation amplitude, attenuation characteristic value and oscillation decay.

35. A method for detecting contamination on a turbine component of a turbine, comprising:
determining a current oscillation characteristic value of a turbine component.
